(19) United States
(12) Patent Application Publication
(10) Pub. No.: US 2018/0001755 A1
(43) Pub. Date: Jan. 4, 2018

(54) EMERGENCY PROTECTIVE DRAPE FOR INCLEMENT WEATHER

(71) Applicant: WEATHER SOLUTIONS, LLC, Washington, DC (US)

(72) Inventors: Candra CUMMINGS, Davidsonville, MD (US); Cherryl BURGESS, Washington, DC (US); Darryl DENNIS, Silver Spring, MD (US)

(21) Appl. No.: 15/600,083

(22) Filed: May 19, 2017

Related U.S. Application Data
(60) Provisional application No. 62/338,981, filed on May 19, 2016.

(51) Int. Cl. B60J 11/04

(52) U.S. Cl. CPC B60J 11/04

(57) ABSTRACT

Provided are protective drapes for e.g., vehicles, which drapes are configured such that they can be applied to an item (such as a vehicle), prior to or during a precipitation event in a manner such that when the drape is removed, precipitation is easily and efficiently removed from the item. Also provided are methods of protecting an item, and methods of removing precipitation from an item that include applying a protective drape in accordance with the present invention, to the item, and removing the protective drape from the item being protected, after at least a portion of the precipitation event. Further provided are kits that include a protective drape in accordance with the present invention, and instructions for applying and/or removing the protective drape from an item to be protected.

### RELATED APPLICATION

The present application claims the benefit of U.S. Provisional application No. 62/338,981, the contents of which are hereby incorporated herein by reference.

### TECHNICAL FIELD

The present invention is directed to an emergency protective drape covers for motor vehicles and other items, such as fire hydrants, which may be outside during inclement weather, for which quick or easy removal of ice, frost snow, and the like may be advantageous. The emergency protective drapes protect against snow, ice, frost and other forms of precipitation. Non-limiting examples of protective drapes within the scope of the present invention may be made e.g., of plastic, such as compostable and/or biodegradable plastic. Example materials for the protective drape may be of varying thickness, for example greater than or equal to 1 millimeter in thickness. The plastic may be made for example of a hydrophobic plastic. The protective drape may have one or more fasteners to attach to the item being covered, for example, with hooks, clips, and/or magnetic contacts for metal surface adhesion. The invention is also directed to methods of quickly and easily removing precipitation from a vehicle or other item involving use of the present protective drape.

### BACKGROUND

Many people who live in areas with snow and ice, have witnessed accidents or near accidents due to chunks of snow and ice flying into the windshield of cars. Laws have been instituted to try to reduce the number and seriousness of accidents caused by snow or ice becoming dislodged from motor vehicles. This situation not only endangers other motorists, may cause windshields to shatter or other property damage.

Because of the danger of such situations, it is illegal in some states to drive with such ice or snow buildup on their vehicle. A handful of states on the east coast, such as New Jersey, Pennsylvania, Massachusetts, New Hampshire and Connecticut, have passed laws requiring drivers of vehicles to remove snow or ice from their cars before driving. In New Jersey, the drivers of commercial vehicles can be fined from $500 up to $1,500 for violating the state's snow and ice removal law, which went into effect in 2010. As a matter of good public policy, many other jurisdictions may add new laws and/or fines to ensure the public safety during these hazardous conditions. However, removing snow, ice and other precipitation from one's car may be difficult, time-consuming and for some drivers, near impossible (e.g., in the case of a tall vehicle, or a thick layer of ice).

In certain circumstances, there is just not time to remove such snow and ice before one needs to drive. For example, first responders, such as fire-fighters, physicians on call, and police may not have time to remove the ice and snow from vehicles to get to where they need to be during an emergency. Additionally, such persons may be out on call or at a hospital, when more precipitation builds up on their vehicle and it may be difficult for them to remove snow or ice from a vehicle in order to go home.

### SUMMARY

The present inventions generally solve the problem of being able to quickly remove snow, ice or other precipitation off of e.g., vehicles, fire hydrants or other items that are outside and exposed to such precipitation.

### BRIEF DESCRIPTION OF THE DRAWINGS

Non-limiting example embodiments described herein, with reference to the following accompanying Figures.

FIG. 1 depicts an example of a car driving with a large chunk of ice and/or snow on top of the vehicle. If this chunk were to become dislodged and fly off the car, it may potentially cause an accident.

FIG. 2 shows ice being scraped off a car by hand, a time consuming and difficult process for some, particularly if an ice scraper is not available.

FIG. 3 depicts a model car covered with a non-limiting example of a protective drape in accordance with non-limiting example embodiments of the present invention.

FIG. 4 depicts the model shown in FIG. 3 having an example protective drape there-over, with imitation snow over the protective drape in accordance with a non-limiting example embodiment to depict how the present imitation drape functions.

FIG. 5 depicts magnets that may be applied or attached to a sheet to form a protective drape in accordance with non-limiting example embodiments of the present invention. The magnet may then serve as a possible fastener/method of attaching the protective drape to the item being protected. According to non-limiting embodiments, the magnets may be relatively flat and/or may be somewhat flexible.

FIG. 6 depicts a strip of magnet (or magnetic tape) that may be used as part of a non-limiting example embodiment of a protective drape in accordance with the present invention. The magnetic material may be cut to a desired size and attached to the protective drape material e.g., by adhesive.

FIG. 7 depicts a sheet of polymer that may be used according to non-limiting example embodiments, to form protective drapes in accordance with the present invention.

FIG. 8 depicts a sheet of polymer having a piece of magnet attached thereto, which may form part of a protective drape in accordance with the present invention.

FIG. 9 depicts a sample attachment clip that may be incorporated into non-limiting example protective drapes in accordance with the present invention. Such clips or other attachments may be used, e.g. to attach the protective drapes to items being protected, e.g. to non-magnetic parts.

FIG. 10 depicts a wooden device that may be used e.g. to help remove the present protective drapes from an item being protected.

FIGS. 11A and 11B depict a non-limiting example of a “small size” protective drape in accordance with non-limiting example embodiments of the present invention, from a top view and perspective view, respectively.

### DETAILED DESCRIPTION

The aspects, advantages and/or other features of example embodiments of the invention will become apparent in view of the following detailed description, taken in conjunction with the accompanying drawings. In describing example embodiments, specific terminology is employed for the sake of clarity. However, the embodiments are not intended to be limited to this specific terminology. It should be apparent to those skilled in the art that the described embodiments of the present invention are merely exemplary and illustrative and not limiting. Numerous embodiments of modifications thereof are contemplated as falling within the scope of the present invention and equivalents thereto. It is to be understood that each specific element includes all technical equivalents that operate in a similar manner to accomplish a similar purpose.

Unless otherwise noted, technical terms are used according to conventional usage.

As used herein, “a” or “an” may mean one or more. As used herein, “another” may mean at least a second or more. Furthermore, unless otherwise required by context, singular terms include pluralities and plural terms include the singular.

The present invention is directed to emergency protective drapes (also referred to herein as “protective drapes” or “drapes”) that may be placed over or applied to a car, truck, emergency vehicle, fire hydrant, or any item that might get covered by snow, ice or other precipitation for which fast and/or easy removal of the precipitation may be desired.

Fitted car covers are difficult to place on a vehicle (and/or remove therefrom) without additional help, in particular, those that are fitted to a certain type of vehicle. Additionally, fitted car covers have a disadvantage in that when a corner is removed (similar to a fitted bed sheet), there may be a flinging action of the corner and anything on top of the cover may fly in an indeterminate direction. The present invention is advantageous over fitted car covers e.g. in that the present drapes allow for controlled placement and removal during inclement weather and are much more easily applied to an item, than a fitted cover, as discussed further below.

As discussed above, a problem exists in which people may be in a situation in which they need to remove precipitation from a car or other item quickly, particularly if they are in a hurry (such as emergency responders). Also, a problem may occur if one is unable to adequately remove precipitation from their car, for example if they are elderly or if it is very difficult to remove the precipitation.

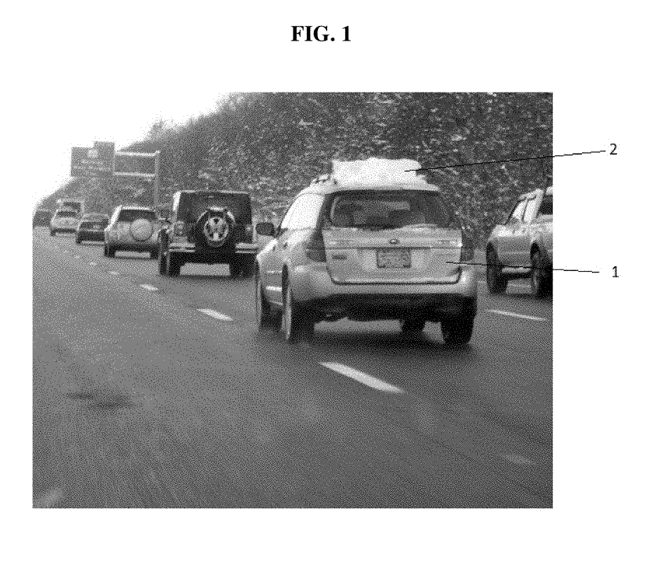

FIG. 1 depicts an example of a car 1 driving with a large chunk of ice and/or snow 2 on top of the vehicle. As shown in FIG. 1, one may be unable (or unwilling) to remove ice/snow from the center/top of their car e.g., due to the positioning of such precipitation. This non-removal may result in a dangerous situation in which the snow or ice may potentially become dislodged and fly off the car and damage another car, or cause an accident. A goal of the present protective drape is to avoid snow/ice missiles from cars or other vehicles, which may be the result of inefficient or insufficient cleaning.

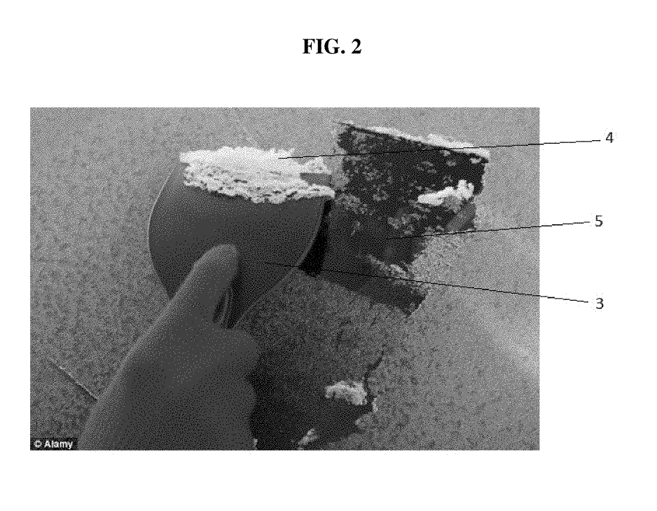

FIG. 2 depicts a common situation in which a scraper 3 must be used after ice/snow/freezing rain/frost 4 for one to be able to see out of their windshield 5. This may be time consuming and difficult. A need exists for a device to avoid such time consuming and difficult scraping. Additionally, wiper blades are often destroyed or damaged by frozen precipitation on a windshield, or by trying to remove such precipitation. This may further impair a driver's view.

Provided herein are methods of removing precipitation from an item, such as a vehicle or a fire hydrant, which methods include applying a protective drape to the item before or during a precipitation event, and removing the protective drape from the item after at least a portion of the precipitation event, thus removing precipitation from the precipitation event from the item. As discussed further herein, the protective drape is a sheet of material that is sized and configured such that the drape is capable of covering the item. According to non-limiting example embodiments, the drape is sized such that it covers at least 75%, at least 80%, at least 90%, or 100% of the item. According to further embodiments, the protective drape has at least two fasteners or attachment mechanisms, such that the drape can be attached to at least two opposite ends of the item.

Also provided herein are the protective drapes themselves, and kits including such protective drapes. Example protective drapes may include a sheet of material sized and configured such that the sheet is capable of covering at least 75% of an item to be covered during a precipitation event, wherein the protective drape has at least two fasteners/attachment mechanisms, such that the protective drape can be attached to at least two opposite ends of the item. As with the methods discussed herein, the drape may be sized such that it covers at least 75%, at least 80%, at least 90%, or 100% of the item. Descriptions of the drape in the context of the present methods herein should be considered to apply to the drape itself, and vice versa.

A precipitation event may include snow, sleet, freezing rain, hail, or any other precipitation event that may result in snow, ice or any other precipitation known to those in the art accumulating on an item exposed to the precipitation event.

The protective drape may be applied prior to the event starting, or even after the event has started (e.g. after snow has begun falling), because it may assist in removing precipitation that accumulates on the item from the time the protective drape is applied until it is removed. Similarly, whether the drape is applied before or during the event, it may be removed at any time after application, whether it is after the precipitation event is completely over, or even before it has finished (for example if an emergency vehicle must be used before the event has ended), because the protective drape will be useful in removing any precipitation from the item from the time it is applied until it is removed.

The emergency protective drapes of the present invention may include for example, a plastic material that is shaped so as to be able to fit over and be attached to the item to be covered, such as a motor vehicle, fire hydrant, or other items that may remain or be kept outside during inclement weather, for which quick or easy removal of ice, snow, and the like may be advantageous.

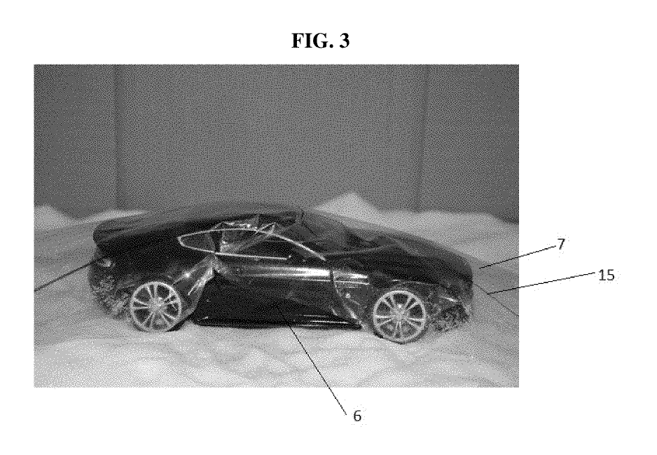

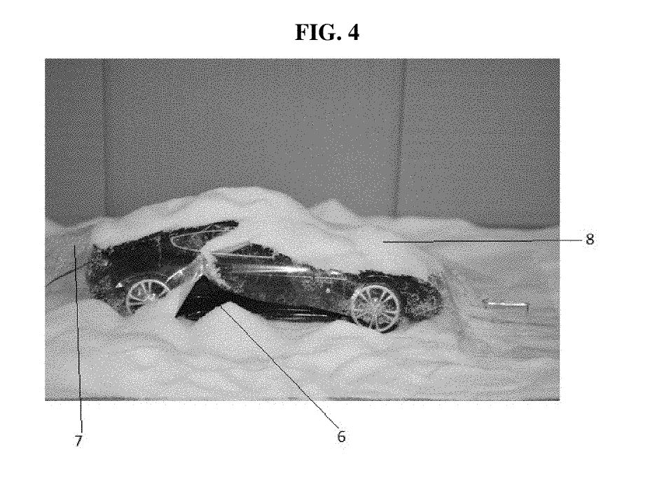

A model car 6 having an example of the present protective drape 7 thereover is shown by way of non-limiting example in FIG. 3. FIG. 4 depicts the model of a car 6 having the drape 7 thereover and further having precipitation 8 on top of the drape. As can be determined from the model, when the drape 7 is removed from the car, all of the precipitation there-over is also removed and the car is cleared quickly and easily.

The material of the emergency protective drapes may be selected such that it is a material suitable for protect against snow, ice, frost and other precipitation.

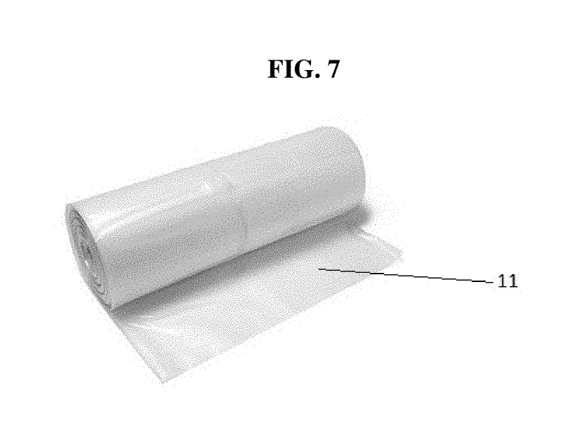

Non-limiting examples of protective drapes within the scope of the present invention may include e.g., a polymer/plastic, such as compostable, and/or biodegradable plastic, as shown for example in FIG. 7. In particular, FIG. 7 depicts a rolled-up sheet of polymer/plastic 11, which may be used to form the present protective drape(s). Thus, according to non-limiting example embodiments, the sheet of material may include polymer material. By way of non-limiting example, the sheet of material may include polypropylene. The sheet may also include multiple sheets of material and/or a material with a suitable coating

Example materials for the protective drape may be of varying thickness, for example greater than or equal to about 1 millimeter in thickness, e.g., 1-2 millimeters thick. Such a thickness may result in a drape that is easily storable when not being used, and may be easily applied over the item to be protected, and/or easily removed from the item being protected. Plastic/polymer or other material having different thicknesses, is contemplated and within the scope of the present invention.

According to non-limiting example embodiments, the material may be made of (or include as an outer layer or coating), for example, a hydrophobic plastic or other material. Such a hydrophobic material may keep water, ice or other precipitation from staying on the item being protected. It would be easier to remove a layer that has no ice on it (over which ice slid off or was repelled off) than one to which ice stuck.

A suitable protective drape material may be determined by one skilled in the art having reviewed this disclosure.

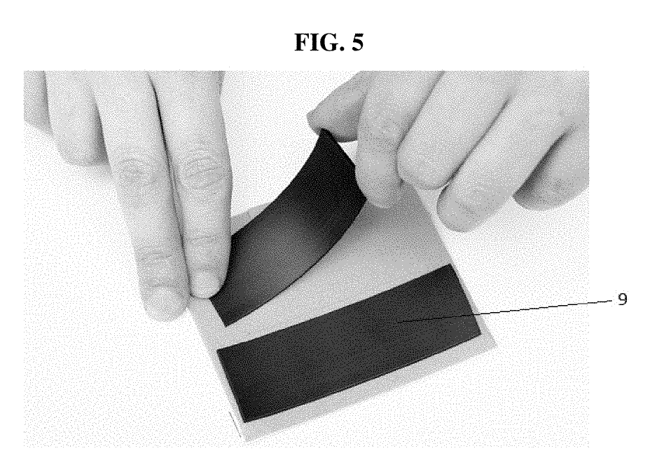

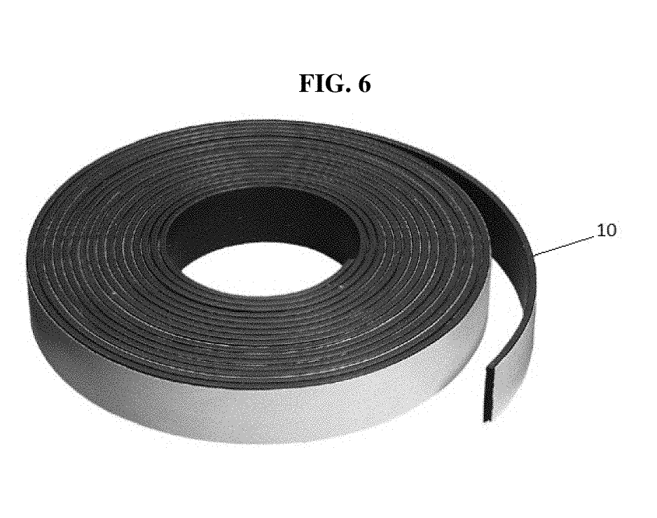

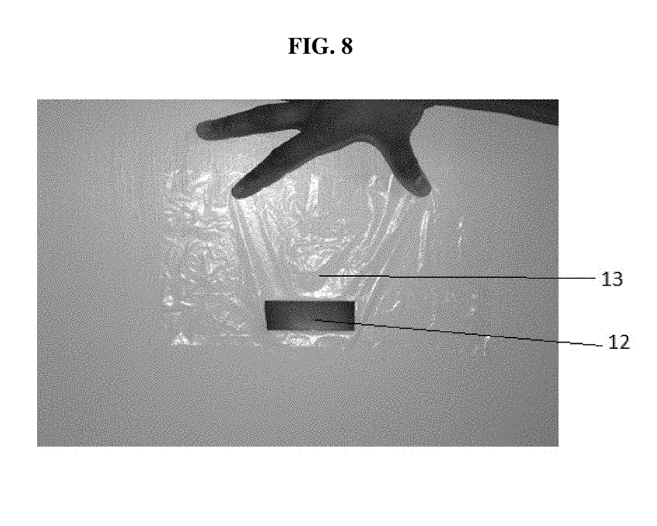

The protective drape may have one or more fasteners or other mechanisms to attach the protective drape to the item being covered, for example, by one or more fasteners or attachment mechanisms, such as hooks, clips, and/or magnetic contacts for metal surface adhesion. The hooks may be for example hooks at one or both ends of the material, and/or one or both sides of the material, depending on the item to be protected. Hooks may be for example, plastic or plastic-coated clips or hooks. Some items to be covered (or portions of items to be covered—such as parts of some cars) may not be metallic or magnetic, so in such a case a hook or clip or cord or other fastening mechanism may be suitable for removably attaching the protective drape to portions of the item to be protected. In non-limiting example embodiments, one or more magnets may help attach the drape to the item to be protected. Magnets may be attached to the drape e.g. by adhesive. For example, looking at FIGS. 5 and 6, magnets 9, 10 may come in strips that can be cut to a desired size and using an adhesive on the back of the magnetic strip, attached to the protective drape (as shown e.g., in FIG. 8, which depicts a magnet 12, that has been cut and attached by adhesive to a plastic sheet 13) either by the manufacturer of the drape, or by an end user. Magnets may come in strips with an adhesive already present on one side of the strip as shown for example in FIG. 6 which depicts a magnet 10 roll, having an adhesive on one side. Such adhesives are typically covered by a paper that may be removed to expose the adhesive. Alternatively, magnets may be attached to the drape by other adhesives.

Magnets that may be used with the present invention may include, but are not limited to flat, square, disk-shaped, or rectangular magnets. Magnets of any suitable shape and size that may be determined by one skilled in the art, may be used to attach the present drapes to a metal part of an item to be protected, such as the metal part of a car.

According to non-limiting example embodiments, the protective drape may include at least two fasteners/attachment mechanisms, which are adapted for attaching the drape to at least two ends of the item to be protected. In the case that the item is a vehicle, the fasteners/attachment mechanisms may be adapted to attach to e.g. at least one of a bumper, hood, license plate, license cover, and/or door of the vehicle.

A fastener or attachment mechanism may be for example, a fastener or attachment mechanism that may be removed from the item to be protected (after use), without damage to the vehicle or item being protected, such as a plastic or plastic-coated clip or hook.

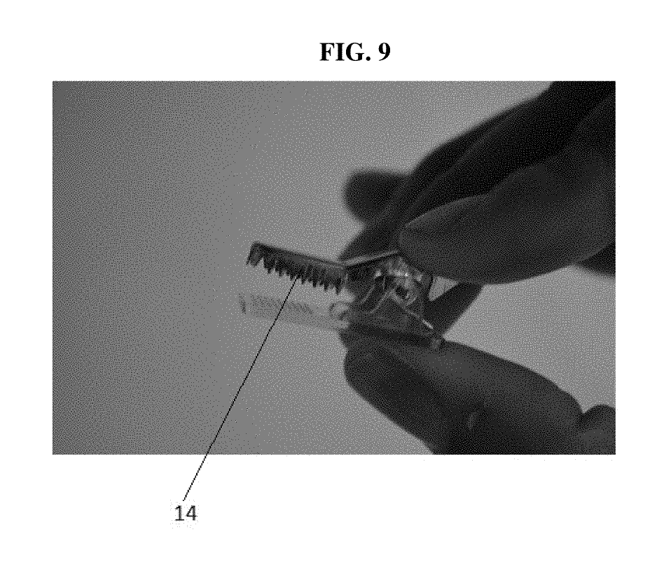

In areas of the item to be protected, such as the front end of a car, the drape may be applied or secured using e.g. metal or plastic clips. Hooks, clips or ties in accordance with the present invention may include any hook or clip or tie or other attachment device (such as the clip 14 shown in FIG. 9, by way of non-limiting example) that may be used to attach the drape material to any portion of an item to be covered in the case of inclement weather, such as a car, truck, emergency vehicle, motorcycle, fire hydrant, etc. For example, clips may be designed to hook to a license plate or front grill of a car. Plastic clips may be advantageous in certain embodiments, so as to make the overall drape recyclable. In this regard, it may be advantageous to have any portion of the drape having magnets, be removable from the drape (e.g. within a perforated portion of the drape that can be removed by a user), such that the drape may be recyclable.

Magnets or clips that form part of the present protective drapes may attach to a vehicle, e.g. by attaching to the door or door jam. The drape may then be further secured by shutting the door with a portion of the protective drape shut in the door.

The present invention is distinguishable over typical car covers, inter alia, in that the present invention is particularly suited for being able to be quickly applied by a user and quickly removed with ice or snow potentially over the top for clearing e.g., a vehicle. The material may be particularly light weight and disposable, and possibly biodegradable or recyclable (particularly, if the magnets are removed). It is contemplated that portions of the drape designed to include the magnetic portions may have perforations for easy removal of the magnetic portion, so that the rest of the drape may be recycled.

The present protective drapes are also distinguishable in that they are not specifically manufactured for one particular vehicle to fit it like a glove, or be a custom cover for one type of car, as opposed to many car covers. But rather, the present protective drapes are designed so that they may fit a variety of items. The protective drapes may come in multiple sizes, such as SUV, truck, minivan, compact vehicle, smaller item, motorcycle, etc. Various names may be assigned to the different sizes, for example by providing dimension ranges, or designating “small”, “medium”, “large”, “extra large”, etc . . . .

Typical vehicle covers also usually have elastic around the bottom of the cover to help provide a form fitting covering. But such covers are disadvantageous in multiple respects. They are expensive and can typically only be used for one type of car. Additionally, they may be difficult to apply quickly, for example, if inclement weather has already begun, or if being applied by one individual.

Non-limiting examples of the present protective drapes provide environmental protection for motor vehicles and other items from inclement weather such as snow, ice, frost, and precipitation. Coverage of motor vehicles enables easy snow removal before driving. The use of e.g., light-weight, disposable, compostable, biodegradable, hydrophobic plastic leaves less carbon foot print due to its eco-friendly composition. According to non-limiting examples, the plastic can be non-toxic.

In accordance with non-limiting examples, the protective drape of the present invention may further include one or more markings to help a user thereof orient or position the drape over the item to be protected. For example, such markings may include e.g. red or other color lines (as depicted by 15 e.g., in FIG. 3) to help center the drape over the car, e.g. by use of a line running through the center of the protective drape, or markings to help show one where fasteners/attachment mechanisms (such as hooks, clips, cords, magnets, etc.) may be located. Markings may also be used to show one which side of the protective drape should be in the front, back, top or bottom, and/or for aligning with a portion of a window, such as the upper/superior portion of a window. Markings may also be used to show where to insert a portion of the protective drape in a door jam for further securing of the drape. Markings may also be used to help one remove the protective drape from a vehicle or other item.

Non-limiting example embodiments of the present protective drapes may meet ASTM D6400, EN13234 and/or BPI standards for compostable materials. The emergency protective drapes are safe for all vehicles and can be easily stored application and removal. Magnetic strips may be used to secure the drape to the vehicle or other item. The hydrophobic nature resists mildew and moisture and exhibits static electricity which enables the plastic drape to adhere to the vehicle due to electron charges that are produced when plastic adheres to metal.

According to non-limiting examples, protective drapes in accordance with the present invention may also include one or more handles, strings, tags or other ways of grabbing on to the protective drape to ease in application and/or removal of the drape.

A kit in accordance with the present invention might include a drape material of the size and/or shape suitable for the item to be covered, and one or more pieces or strips of magnetic material, or other magnet(s) to be secured to the drape by the end user.

Other example kits in accordance with the present invention may include one or more protective drapes, or portions thereof, and instructions for the use, such as application and/or removal of the drape from an item to be protected.

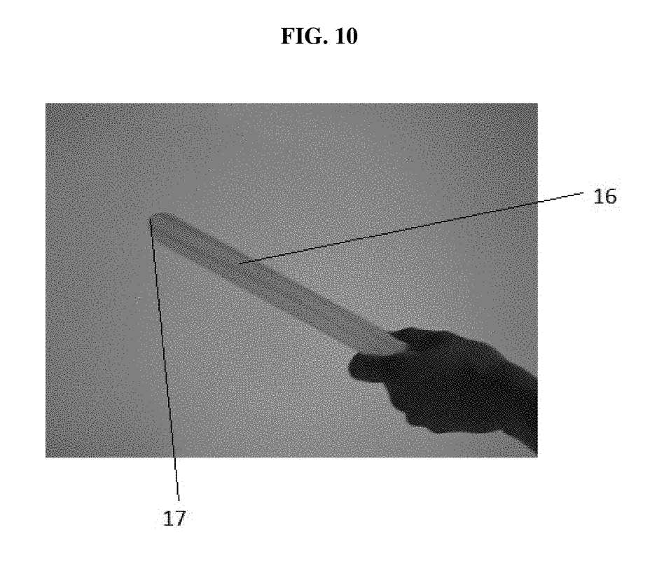

Further example kits in accordance with the invention may include a device to assist in application and/or removal of the protective drape from an item (e.g. vehicle) to be protected. Such a device may be e.g. a wooden applicator or apparatus 16, such as that shown in FIG. 10. The wooden stick or applicator of FIG. 10 may be of a shape and size to assist with removal of the drape (e.g., having at least two flat sides), and may also be configured (e.g. with rounded corners or ends 17) to try to eliminate or reduce any damage to the item being protected (e.g. to avoid damaging the paint of the car). The device may also be configured so as to protect a user's fingers/hands during application of the protective drape, for example, while tucking the drape into a door frame or in the door jam. Such a device may also be used to help spread or move or cling the protective drape to a car.

Accordingly, non-limiting example embodiments herein are directed to kits that include at least one protective drape in accordance with embodiments herein and instructions for applying the protective drape to an item to be protected. The kit may further include instructions for removing the protective drape from the item to be protected. According to further embodiments, the present kits may include at least one wooden applicator having two flat sides and at least one curved end.

According to non-limiting examples, the protective drapes of the present invention may be stored in the vehicle for quick and easy application.

Other embodiments herein are directed to methods of making the present protective drapes, which may be determined by reviewing the present disclosure.

Advantages of the present invention may include not having to use a brush or ice scraper to take off snow and ice from the windshield, side mirrors headlights, wheel wells, and tailpipe of a vehicle, which can save considerable time and effort, particularly, when someone must get in and use their vehicle quickly, and/or if the outside conditions remain adverse—such as snow continuing to fall or frigid temperatures. Snow buildup in tailpipe may result in possible carbon monoxide poisoning in one's vehicle if the car is running, but the tailpipe not clear. Thus, another advantage of the present invention is that when the protective drape covers the tailpipe during use, then when the drape is removed, the tailpipe would be cleared (along with other parts of the vehicle), thus avoiding possible carbon monoxide poisoning upon starting the vehicle.

The devices and methods of the present invention may also help prevent frozen wipers, that is, wipers being frozen to a windshield, by rain, ice or snow, or other precipitation freezing to the vehicle after falling onto the vehicle. The present invention, also prevents one having to have on hand and using a de-icing fluid on the windshield.

As discussed above, embodiments of the present invention are directed to methods of protecting an item from precipitation by applying a protective drape in accordance with the present invention to the item (such as a car, truck, emergency vehicle, fire hydrant) before or during the precipitation event and thereafter removing the protective drape from the item to remove the precipitation. A non-limiting example of such a method is provided in the following Example.

### Example

A car or other vehicle may be protected by the present protective drapes by e.g. the following method. First, certain safety precautions should be observed. The vehicle should be turned off and unoccupied during application and removal of the protective drape. One should ensure the safety of children and individuals around the drape at all times, even when it is not in use. This is not a toy and poses a suffocation and choking hazard.

Effective usage of the present protective drapes, are conditioned as follows: Do not apply the drape to the vehicle if the wind is >40 mph, as it may fly off, or if the temperature is greater than 70° F.

One should also note that fastener magnets used in conjunction with the drape may interfere with the function of pacemaker devices when in direct contact. Therefore, safety precautions and warnings may be provided with the drape itself, and/or on a website or at point of sale.

In embodiments in which the drape has red (or other color) lines or symbols to help with application of the drape, one may open the package containing a drape and line up the red line (or other symbol) “right angle” or approximately 90° to the top door edge and superior aspect of the windshield of the vehicle from the right side. See FIG. 3. Unfold the drape, which may be folded e.g. as an accordion, and drape the length of the drape over the vehicle as depicted by way of model in FIG. 3.

Next, open vehicle doors (such as the front doors) and secure one or more of the drape's magnets (e.g. magnetic strips) to the door jamb(s) or other magnetic location of the vehicle. The drape may be secured in the door jamb, e.g. using a wooden applicator, such as that depicted in FIG. 10.

The drape is then secured inside the door jambs and/or window on the front doors. One may then gently close the door(s) onto the drape while removing the wooden applicator essentially simultaneously. One person may perform this method on each of the front door jambs sequentially, or two or more people may secure the drape essentially simultaneously. In the case of one person, after the drape is secured to one front door jamb, the method is repeated on the opposite side of the vehicle, that is, open the door and secure drape to the door jamb using a magnet and wood applicator as previously described.

The drape is then spread over the front of the vehicle and a clip or other fastener/attachment may be used to attach the drape to other portions of the car, such as to the front license plate holder bracket.

One may then spread the drape over the rear of the vehicle ensuring that the magnet adheres to the metal trunk area (if a magnet is used as a fastener for the rear of the vehicle). One may also adjust the drape over the rear of the vehicle and secure drape using a clip to e.g., the back license plate. It is not imperative that the front of the drape be secured prior to the back of the drape being secured, thus, this order may be reversed.

When the vehicle is wet, it may be more difficult to apply the protective drape (which may be plastic), over the vehicle. One may wish to lock their car doors remotely after the drape is applied to a vehicle.

Safety precautions should also be observed with respect to removal of the present drape. Again, one should ensure that the environment around them is safe before proceeding forward.

First, if the doors are locked, one may remotely, unlock their doors. Then, unclip the rear clip or detach any rear magnets and ensure that the tailpipe is cleared of snow and/or plastic. Unclip the front clip or attachment. As with application of the drape, the front and rear detachment may be reversed. Next one would open one of the front doors and remove the magnet and drape from the door jamb. On the opposite side, open the door and remove the magnet and drape.

A storage bag may be used to enable proper storage/disposal of the drape after it is removed.

Thus, in accordance with non-limiting example embodiments, methods herein may include applying a protective drape to a vehicle, before or during a precipitation event, by lining up markings on a protective drape at a right angle to a top door edge of a vehicle, and unfolding the protective drape over the vehicle. Application may include securing the drape inside the door jambs and/or door windows and closing the door onto the drape on one or both sides of the vehicle. Application may also include spreading the drape over the front and rear of the vehicle and attaching the drape to the front and back of the vehicle using one or more fasteners or other attachment devices. The present methods also include removing the protective drape from the vehicle after at least a portion of the precipitation event, thus removing precipitation from the precipitation event from the item. Such removal may include e.g., remotely unlocking doors of the vehicle and detaching the front and/or back attachment device, and opening the doors and/or windows that have the drape attached thereto to remove the drape therefrom, then removing the entire drape (including any precipitation thereon) from the vehicle.

### Example 2

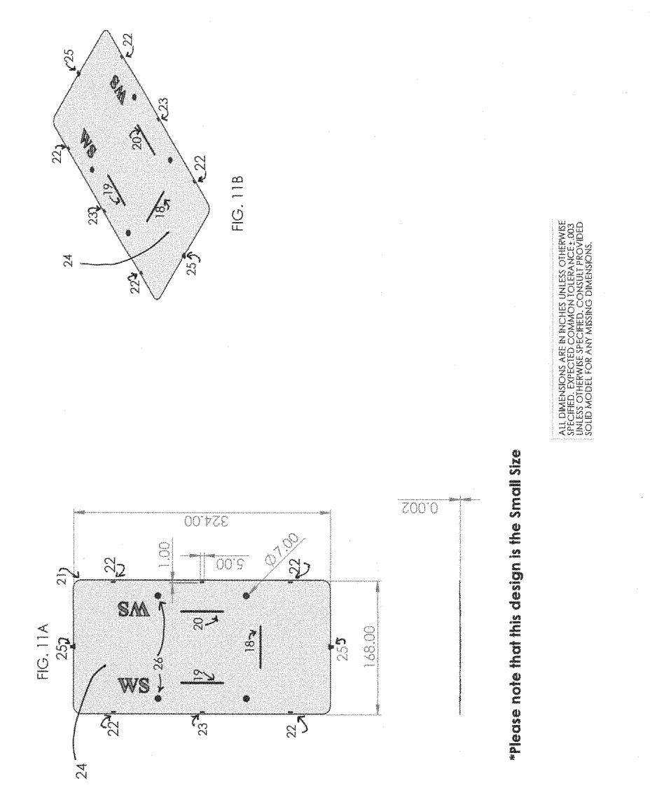

Example 2 is an example of a “small size” protective drape 24 shown in FIGS. 11A and 11B, which may be used in accordance with non-limiting example embodiments of the present invention. In particular, FIGS. 11A and 11B depict a protective drape 24 that is made of a clear, hydrophobic, plastic sheet. In this example, the plastic sheet is 168 inches by 324 inches and is 1 mil. thick. The dimensions depicted in the example may be varied depending on the type of item to be protected.

In this example embodiment, horizontal line 18 may be e.g. red in color and may be solid or dashed. In the example size provided, the line 18 is 21 inches long and 1 inch wide for visibility and depicts the orientation of the Emergency Protective Drape. Line 18 aligns parallel and center with the top/superior portion of the front window of a vehicle. The term “superior” is intended to denote location, not quality.

Line 19 in FIGS. 11A and 11B is 19 inches long and is to be aligned with the superior/top part of the passenger windows in front and back.

Line 20 is 19 inches long, may be red in color, and is to be aligned with the superior/top part of the driver's and rear passenger window on the left side of vehicle.

The designation “WS” in FIGS. 11A and 11B is the logo, and may be e.g., 18 inches wide on both sides of the rear part of the drape. The color can be anything except clear. The Logo or other symbol on the drape may in example embodiments be reflective at night.

Magnets 22 adhere the drape to the doors (metal). The magnets are strong and can withstand windy conditions. The minimal thickness of the magnets is 0.30 mil and may be approximately the size of a quarter each, but as indicated herein, may be in the shape of a square, rectangle, disk or any other suitable shape. The magnets are not attached to the windows.

Magnets 23 are magnets that are attached to the metal in the door jam. The thickness, shape, and size of the magnets 23 may be similar to magnets 22.

Plastic or plastic-coated clips 25 attach the drape to the front and rear of the vehicle. The clips are plastic and or plastic coated metal and attach to the back and front license plate or rim of the vehicle, e.g. in cases where there is not a plate.

As shown in FIGS. 11A and 11B, the corners 21 of the protective drape may be rounded. It is noted that dots 26 are shown on the example embodiment, where optional grommets may be used for use with optional further fasteners/attachment mechanisms, but such grommets are not included in preferred embodiments.

Other fasteners and/or methods of applying and or removing the protective drape of the present invention may be apparent or developed by one having the present description in mind, depending e.g. on the type, size and shape of the vehicle being protected. For example, if an ambulance is being draped, modified magnet shape and/or positioning and a modified technique may be required, as compared to that for a sedan.

While certain features of the described implementations have been illustrated as described herein, many modifications, substitutions, changes and equivalents will now occur to those skilled in the art. It is, therefore, to be understood that the present application is intended to cover all such modifications and changes as fall within the scope of the embodiments.

We claim:

1. A method of removing precipitation from an item, comprising
applying a protective drape to the item before or during a precipitation event, and
removing the protective drape from the item after at least a portion of the precipitation event, thus removing precipitation resulting from the precipitation event from the item;
wherein the protective drape comprises a sheet of material sized and configured such that the drape is capable of covering at least 75% of the item, and has at least two fasteners, such that the drape can be attached to at least two opposite ends of the item.

2. The method of claim 1, wherein the item is a vehicle.

3. The method of claim 2, wherein the at least two fasteners are adapted for attaching to at least one of a bumper, hood, license plate, license cover, and door of the vehicle.

4. The method of claim 1, wherein the precipitation event is snow.

5. The method of claim 1, wherein the sheet of material comprises a polymer material.

6. The method of claim 1, wherein the sheet of material comprises a hydrophobic material.

7. The protective drape of claim 4, wherein the sheet of material comprises polypropylene.

8. The method of claim 1, wherein the sheet of material is 1 to 2 mm thick.

9. The method of claim 1, wherein the at least two fasteners are selected from the group consisting of hooks, clips, cords, and magnets.

10. The method of claim 1, wherein the protective drape has markings to assist a user in aligning the protective drape over the item.

11. A protective drape comprising:
a sheet of material sized and configured such that the sheet is capable of covering at least 75% of an item to be covered during a precipitation event,
wherein the protective drape has at least two fasteners, such that the protective drape can be attached to at least two opposite ends of the item.

12. The protective drape of claim 11, wherein the item is a vehicle and the at least two fasteners are adapted for attaching to at least one of a bumper, hood, license plate, license cover, and door of the vehicle.

13. The protective drape of claim 11, wherein the sheet of material comprises a polymer material.

14. The protective drape of claim 11, wherein the sheet of material comprises a hydrophobic material.

15. The protective drape of claim 11, wherein the sheet of material comprises polypropylene.

16. The protective drape of claim 11, wherein the sheet of material is 1 to 2 mm thick.

17. The protective drape of claim 11, wherein the at least two fasteners are selected from the group consisting of hooks, clips, cords and magnets.

18. The protective drape of claim 11, wherein the protective drape has markings to assist a user in aligning the protective drape over the item.

19. A kit comprising at least one protective drape in accordance claim 11, and instructions for applying the protective drape to an item to be protected and/or removing the protective drape from the item.

20. The kit of claim 19, further comprising at least one wooden applicator having two flat sides and at least one curved end.
